(19) United States
(12) Patent Application Publication
(10) Pub. No.: US 2016/0289363 A1
(43) Pub. Date: Oct. 6, 2016

(54) POLYMERS WITH SILICON-CONTAINING STRUCTURAL UNITS AND COATING COMPOSITIONS INCLUDING THESE POLYMERS

(71) Applicant: WATEVER INC., Waterloo (CA)

(72) Inventors: Yongxin WANG, Waterloo (CA); Xianguo LI, Waterloo (CA)

(21) Appl. No.: 15/035,150

(22) PCT Filed: Nov. 6, 2013
(86) PCT No.: PCT/CA2013/000951

§ 371 Date: May 6, 2016

(51) Int. Cl. C08F 230/08; C09D 143/04

(52) U.S. Cl. CPC C08F 230/08; C09D 143/04

(57) ABSTRACT

A polymer and a coating composition comprising the polymer are provided. The polymer has the formula R¹¹QR¹², wherein R¹¹ and R¹² are H, OH or an organic group, and Q represents [—P—]_{N}— Moiety P, at each occurrence is, independently, A¹, A² or R¹³, and Q has at least two A¹ units and at least two A² units. A¹ has structural formula (1a), A² has structural formula (1b) and R¹³ is a divalent organic group. In structures (1a) and (1b) radicals R¹ and R⁶ are H or an organic group and R²-R¹⁰ represent organic groups. A coating composition comprising the polymer and articles coated with the composition are also disclosed.

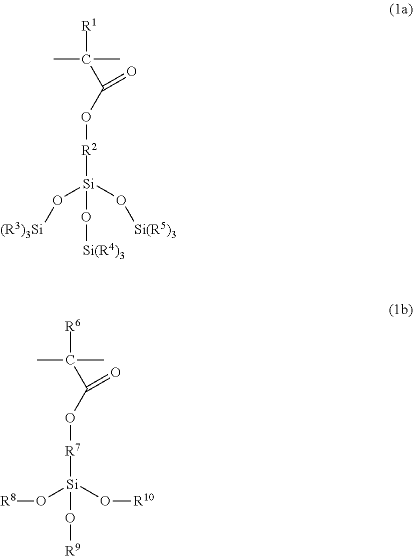

### TECHNICAL FIELD

This relates to a novel polymer, and a coating composition of the polymer.

### BACKGROUND

Wood, glass, ceramics, masonry and metal are widely utilized in the constructions of buildings and building products such as windows, floors, furniture, doors and fences in view of their advantages of easy processing, high strength and relatively low cost. It is also well known that these materials are generally porous on structures and easily soaked by liquids. In some cases, they could deteriorate under the influence of outdoor environment (e.g., rain, snow, ultraviolet (UV) lights), or fade in colour over time (e.g. by virtue of spill of beverages, oils). After a period of time, they can become spotted in appearance, lose mechanical strength or undergo dimensional change. The latter two types of deterioration also cause safety concerns. To mitigate this, it is common to coat or treat their surfaces with water-repellant coatings or paints. Additionally, some materials, such as glass and fabrics, have a self-cleaning requirement, and other materials, such as steel, have anti-corrosion requirements, and water proofing coatings are often applied to such materials so as to satisfy these requirements.

In general, slack wax, polytetrafluoroethylene (PTFE) or silicone has been used as a coating material. Slack wax is widely used because of its advantages of relatively low price, safe to use and ease of processing. Woods and bricks can be quickly treated by slack wax, which provides them with shiny and water repellent surfaces. Also, waxed surfaces significantly reduce water absorption (U.S. Pat. App. No. 20100249283; U.S. Pat. No. 2,231,486; U.S. Pat. No. 4,360,385). However, the drawback is that excessive amounts of slack wax reduces the bonding action between material elements and make subsequent operations more difficult. Additionally, the treated surfaces (e.g., floor) may pose a slippery hazard. Slack wax is also difficult to bond to some substrates, and has a low melting point (less than 70° C.), rendering it inappropriate for certain applications.

A potential alternative is a varnish, such as polyurethane, which has better hardness, transparency and durability. However, the drawback is that it strongly absorbs UV irradiation, which can cause premature degradation. The varnish film tends to become brittle and can be easily peeled off substrates. Also, the varnish film is also transparent to UV light. In this respect, colors present in varnished substrates, such as wood and brick, are susceptible to fading (J. Paint Tech., 531 (41) 275, 1969).

Polytetrafluoroethylene (“PTFE”) is famous for its non-stick, high water-repellent properties, and is widely used in coating application (U.S. Pat. No. 3,055.852; U.S. Pat. No. 4,857,578). However, it suffers from poor solubility in solvents. One approach to resolve this issue is to disperse PTFE particles and other film-forming agents in an organic solvent. In this way, PTFE becomes embedded in the final coating as it is cured. However, with this method, there is a concern about uniformity of the final coatings. Another approach is using water-based PTFE production, (i.e., PTFE emulsion), which works well on bricks and masonry, but is less compatible with woods. This is because the surfactants used in emulsion are difficult to remove from the woods, resulting in a more hydrophilic final coating. Additionally, perfluorooctanoic acid (PFOA), the surfactant in producing PTFE, is a carcinogen. The byproduct of PTFE decomposition is also a health concern, and can cause flu-like symptoms in humans (DuPont, Key Questions about Teflon, accessed on 3 Dec. 2007).

Apart from PTFE, silicone and silicon-based compounds are also known as low surface energy materials. For examples, JP-A 63-265601 discloses an impregnating method, where silicone polymers are formed within cell walls of woods. This method appears to be effective for prohibiting water absorption, but less effective for improving dimensional stability. U.S. Pat. No. 7,658,972 discloses a silicone emulsion for waterproofing woods, wherein the main component of emulsion is organopolysiloxane, and such emulsion is cured by the reaction between amino and epoxy. Organosilane quaternary nitrogen compounds have also been employed effectively for imparting water and various stains, as described in U.S. Pat. No. 7,589,054; U.S. Pat. No. 7,658,972. Silicone products have significant advantages of flexibility, transparency, and resistance to extreme temperatures (−55° C. to +300° C.). One concern about silicone products is their lack of mechanical strength. Additionally, the low surface energy property of silicone product can cause poor bonding with substrates.

Until now, studies on superhydrophobic surfaces have attracted much attention. A superhydrophobic surface, upon which the static water contact angle is more than 150°, and the sliding angle is less than 5°, may generally be prepared by the combination of low surface energy materials and the appropriate surface roughness ((a) T. Onda, S. Shibuichi, N. Satoh, K. Tsujii, Langmuir 1996, 12, 2125. (b) T. Tsujii, T. Yamamoto, T. Onda, S. Shibuichi Angew. Chem., Int. Ed. Engl. 1997, 36, 1011. (c) J. P. Youngblood, T. J. McCarthy Macromolecules 1999, 32, 6800. (d) X. Feng, Jiang, L. Adv. Mater. 2006, 18, 3063). However, these superhydrophobic surfaces require special designs on the surface structures, which are not suitable for materials with original complicated surface structures like wood or ceramic tiles, and also not suitable for materials with a transparency requirement, such as glass.

### SUMMARY

In one aspect, there is provided a polymer having the structural formula:

R¹¹QR¹²;
wherein R¹¹ is a hydrogen atom, a hydroxyl group, or a monovalent organic group;
and wherein R¹² is a hydrogen atom, a hydroxyl group, or a monovalent organic group;
and wherein Q represents P_{N};
and wherein P, in each occurrence, independently, is A¹, A², or R¹³,
and wherein A¹ has the structural formula (1a):

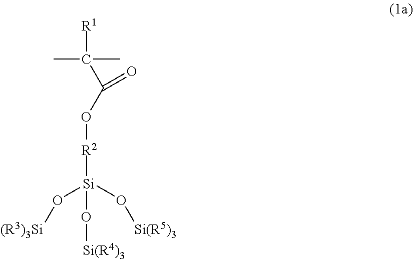

wherein R¹ is a hydrogen atom, or a monovalent organic group having 1 to 10 carbon atoms in total;
and wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein A² has the structural formula (1b):

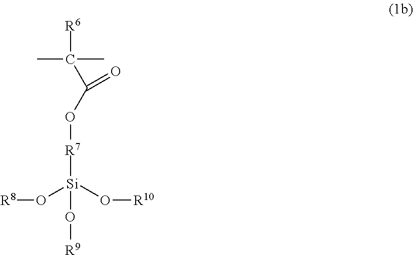

and wherein R⁶ is a hydrogen atom or a monovalent organic group having 1 to 10 carbon atoms in total;
and wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁰ is a monovalent organic group having 1 to 15 carbon atoms in total;
and wherein R¹³ is a divalent organic group;
and wherein N is an integer that is greater than or equal to two (2);
with the proviso that Q has at least two (2) but less than 10,000 units of A¹ in total, and at least two (2) but less than 10,000 units of A² in total.

In a further aspect, there is provided a polymer comprising two or more side chains (SC¹) and two or more side chains (SC²);
wherein the side chain (SC¹) has a structural formula (2a):

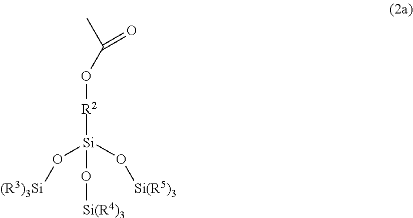

wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein side chain (SC²) has a structural formula (2b):

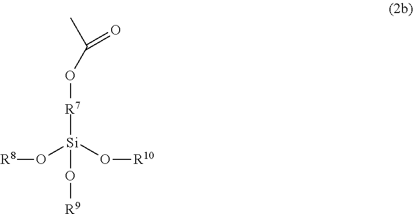

wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁰ is a monovalent organic group having 1 to 15 carbon atoms in total.

In another aspect, there is provided a polymer comprising two or more structural units (SU¹) and two or more structural units (SU²);
wherein the structural unit (SU¹) has a structural formula (3a):

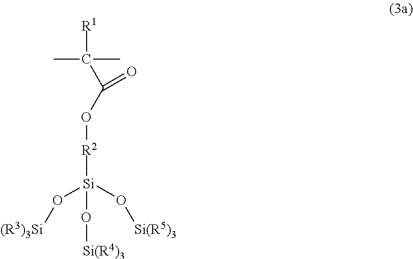

wherein R¹ is a hydrogen atom, or a monovalent organic group having 1 to 10 carbon atoms in total;
and wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein the structural unit (SU²) has a structural formula (3b):

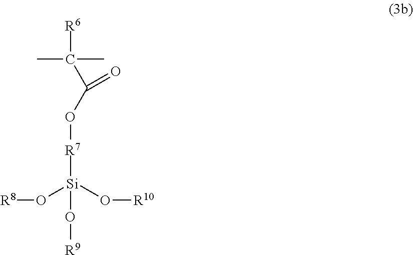

wherein R⁶ is a hydrogen atom or a monovalent organic group having 1 to 10 carbon atoms in total;
and wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁰ is a monovalent organic group having 1 to 15 carbon atoms in total.

In another aspect, there is provided a polymer obtainable by co-polymerizing monomer (M¹) and monomer (M²) within a reaction zone;
wherein the monomer (M¹) has a structural formula (4a), as follows:

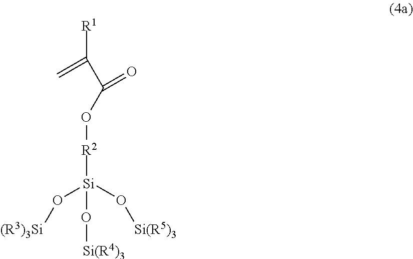

wherein R¹ is a hydrogen atom, or a monovalent organic group having 1 to 10 carbon atoms in total;
and wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein the monomer (M²) has a structural formula (4b), as follows:

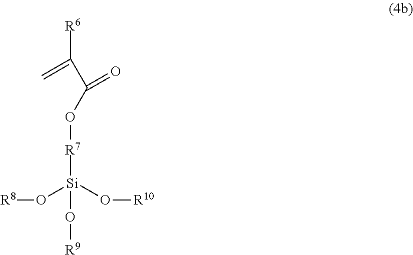

wherein R⁶ is a hydrogen atom or a monovalent organic group having 1 to 10 carbon atoms in total;
and wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁰ is a monovalent organic group having 1 to 15 carbon atoms in total.

In a further aspect, there is provided a coating composition comprising an operative polymer material and an operative solvent material. The operative polymer material consists of one or more of any one of the polymers described above. The operative solvent material includes one or more solvents.

In a further aspect, there is provided an article comprising a substrate to which such coating composition has been applied.

### BRIEF DESCRIPTION OF DRAWINGS

The embodiments will now be described with reference to the following accompanying drawings, in which:

FIG. 1 is a graph illustrating anti-corrosion characteristics of an embodiment of the coating composition.

### DETAILED DESCRIPTION

Unless stated otherwise, such as in the examples, all amounts and numbers used in this specification are intended to be interpreted as modified by the term “about”.

(A) Operative Polymer

There is provided an operative polymer.

### First Aspect of the Operative Polymer

In one aspect, the operative polymer has the structural formula (1):

R¹¹QR¹² (1),
wherein R¹¹ is a hydrogen atom, a hydroxyl group, or a monovalent organic group;
and wherein R¹² is a hydrogen atom, a hydroxyl group, or a monovalent organic group;
and wherein Q represents P_{N};
and wherein P, in each occurrence, independently, is A¹, A², or R¹³,
and wherein A¹ has the structural formula (1a):

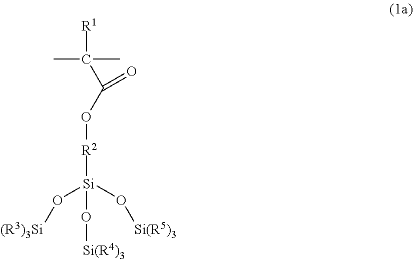

wherein R¹ is a hydrogen atom, or a monovalent organic group having 1 to 10 carbon atoms in total;
and wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein A² has the structural formula (1b):

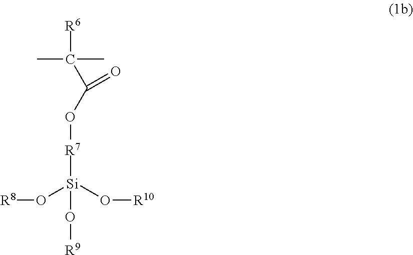

and wherein R⁶ is a hydrogen atom or a monovalent organic group having 1 to 10 carbon atoms in total;
and wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁰ is a monovalent organic group having 1 to 15 carbon atoms in total;
and wherein R¹³ is a divalent organic group;
and wherein N is an integer that is greater than or equal to two (2);
with the proviso that Q has at least two (2) but less than 10,000 units of A¹ in total, and at least two (2) but less than 10,000 units of A² in total.

It is understood that the A¹ and the A² units may be arranged randomly, alternatively, or in block structure.

The A¹ groups contribute hydrophobic characteristics to the operative polymer. In some embodiments, for example, when the operative polymer is disposed in a coating composition including a curing agent, the A² groups are configured to co-operate with a substrate, after, at least, disposition of the coating composition in contact engagement relationship with the substrate in a contacting zone is effected, such that association between the operative polymer and the substrate is effected. In some embodiments, for example, the association includes chemical bonding.

With respect to R¹¹, when R¹¹ is a monovalent organic group, in some embodiments, for example, R¹¹ has 1 to 10 carbon atoms in total. In some embodiments, for example, the monovalent organic group may be substituted or unsubstituted, and may include one or more heteroatoms, and may be saturated or unsaturated, and may be linear, branched or cyclic. In some embodiments, for example, the monovalent organic group may be an epoxy group or an isocyano group. In some embodiments, for example, the monovalent organic group is a monovalent hydrocarbon group. In some embodiments, for example, the monovalent hydrocarbon group is an aliphatic group. In some embodiments, for example, the aliphatic group is a vinyl group. In some embodiments, for example, the aliphatic group is a linear aliphatic group. In some embodiments, for example, the aliphatic group is an alkyl group. In some embodiments, for example, the alkyl group is any one of a methyl group, an ethyl group, a propyl group, a butyl group, or an isobutyl group, or a vinyl group.

With respect to R¹², when R¹² is a monovalent organic group, in some embodiments, for example, R¹² has 1 to 10 carbon atoms in total. In some embodiments, for example, the monovalent organic group may be substituted or unsubstituted, and may include one or more heteroatoms, and may be saturated or unsaturated, and may be linear, branched or cyclic. In some embodiments, for example, the monovalent organic group may be an epoxy group or an isocyano group. In some embodiments, for example, the monovalent organic group is a monovalent hydrocarbon group. In some embodiments, for example, the monovalent hydrocarbon group is an aliphatic group. In some embodiments, for example, the aliphatic group is a vinyl group. In some embodiments, for example, the aliphatic group is a linear aliphatic group. In some embodiments, for example, the aliphatic group is an alkyl group. In some embodiments, for example, the alkyl group is any one of a methyl group, an ethyl group, a propyl group, a butyl group, or an isobutyl group, or a vinyl group.

With respect to R¹, in some embodiments for example, R¹ has 0 to 4 carbon atoms in total. If R¹ has an excessive number of carbon atoms, the monomer from which the structural unit is derived is more difficult to polymerize. When R¹ is a monovalent organic group, the monovalent organic group may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R², in some embodiments, for example, R² has 1 to 10 carbon atoms in total. In some embodiments, for example, R² has either 3 or 4 carbon atoms in total. If R² has an excessive number of carbon atoms, the polymer is more difficult to dissolve. The divalent organic group of R² may be substituted or unsubstituted, and may include one or more heteroatoms, and may be saturated or unsaturated, and may be linear, branched or cyclic. In some embodiments, for example, the divalent organic group is a divalent hydrocarbon group. In some embodiments, for example, the divalent hydrocarbon group is an aliphatic group. In some embodiments, for example, the aliphatic group is a linear aliphatic group. In some embodiments, for example, the aliphatic group is an alkylene group.

With respect to R³, in some embodiments, for example, R³ has 1 to 6 carbon atoms in total. In some embodiments, for example, R³ has 1 to 3 carbon atoms in total. If R³ has an excessive number of carbon atoms, the polymer is more difficult to dissolve. The monovalent organic group of R³ may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R⁴, in some embodiments, for example, R⁴ has 1 to 6 carbon atoms in total. In some embodiments, for example, R⁴ has 1 to 3 carbon atoms in total. If R⁴ has an excessive number of carbon atoms, the polymer is more difficult to dissolve. The monovalent organic group of R⁴ may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R⁵, in some embodiments, for example, R⁵ has 1 to 6 carbon atoms in total. In some embodiments, for example, R⁵ has 1 to 3 carbon atoms in total. If R⁵ has an excessive number of carbon atoms, the polymer is more difficult to dissolve. The monovalent organic group of R⁵ may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R⁶, in some embodiments for example, R⁶ has 0 to 4 carbon atoms in total. If R⁶ has an excessive number of carbon atoms, the monomer from which the structural unit is derived is more difficult to polymerize. When R⁶ is a monovalent organic group, the monovalent organic group may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R⁷, in some embodiments, for example, R⁷ has 1 to 10 carbon atoms in total. In some embodiments, for example, R⁷ has either 3 or 4 carbon atoms in total. If R⁷ has an excessive number of carbon atoms, the polymer is more difficult to dissolve. The divalent organic group of R⁷ may be substituted or unsubstituted, and may include one or more heteroatoms, and may be saturated or unsaturated, and may be linear, branched or cyclic. In some embodiments, for example, the divalent organic group is a divalent hydrocarbon group. In some embodiments, for example, the divalent hydrocarbon group is an aliphatic group. In some embodiments, for example, the aliphatic group is a linear aliphatic group. In some embodiments, for example, the aliphatic group is an alkylene group.

With respect to R⁸, in some embodiments, for example, R⁸ has 1 to 6 carbon atoms in total. In some embodiments, for example, R⁸ has 1 to 3 carbon atoms in total. If R⁸ has an excessive number of carbon atoms, the polymer is more difficult to dissolve. The monovalent organic group of R⁸ may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R⁹, in some embodiments, for example, R⁹ has 1 to 6 carbon atoms in total. In some embodiments, for example, R⁹ has 1 to 3 carbon atoms in total. If R⁹ has an excessive number of carbon atoms, the polymer is more difficult to dissolve. The monovalent organic group of R⁹ may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R¹⁰, in some embodiments, for example, R¹⁰ has 1 to 6 carbon atoms in total. In some embodiments, for example, R¹⁰ has 1 to 3 carbon atoms in total. If R¹⁰ has an excessive number of carbon atoms, the polymer is more difficult to dissolve. The monovalent organic group of R¹⁰ may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R¹³, the divalent organic group of R¹³ may be substituted or unsubstituted, and may include one or more heteroatoms, and may be saturated or unsaturated, and may be linear, branched or cyclic. In some embodiments, for example, the divalent organic group is a divalent hydrocarbon group. In some embodiments, for example, the divalent hydrocarbon group is an aliphatic group. In some embodiments, for example, the aliphatic group is a linear aliphatic group. In some embodiments, for example, the aliphatic group is an alkylene group.

In some embodiments, for example, Q has between 500 and 10,000 units of A¹ in total, and between 500 and 10,000 units of A² in total. In some embodiments, for example, Q has between 500 and 5,000 units of A¹ in total, and between 500 and 5,000 units of A² in total. In some embodiments, for example, Q has between 1,000 and 10,000 units of A¹ in total, and between 1,000 and 10,000 units of A² in total. In some embodiments, for example, Q has between 1,000 and 5,000 units of A¹ in total, and between 1,000 and 5,000 units of A² in total. In some embodiments, for example, Q has between 2,500 and 5,000 units of A¹ in total, and between 2,500 and 10,000 units of A² in total. In some embodiments, for example, Q has between 2,500 and 10,000 units of A¹ in total, and between 2,500 and 5,000 units of A² in total.

In some embodiments, for example, the ratio of the total number of units of A¹ to the total number of units of A² is between 20:1 and 1:10. It has been found that, above the lower limit, coating compositions incorporating such polymers have desirable hydrophobic characteristics while still displaying sufficient durability. If this ratio is above 20:1, it would be difficult to effect the association between the polymer and a substrate when the polymer is included within a coating composition that is applied to the substrate (see below). In some embodiments, for example, this ratio is between 10:1 and 1:1. In some embodiments, for example, this ratio is between 5:1 and 1:1. In some embodiments, for example, this ratio is 2:1.

In some embodiments, for example, the weight average molecular weight of the operative polymer is between 2,000 and 500,000. In some embodiments, for example, the weight average molecular weight of the operative polymer is between 10,000 and 500,000. In some embodiments, for example, the weight average molecular weight of the operative polymer is between 50,000 and 500,000. If the operative polymer has a weight average molecular weight that is higher than 500,000, it would be difficult to re-disperse the operative polymer in a solvent and the final coating will impair the appearance of the treated substrate. If the operative polymer has a weight average molecular weight that is lower than 2,000, it would be difficult to cure the operative polymer.

In some embodiments, for example, to R¹³ may be A³, wherein A³ has the structural formula (1c):

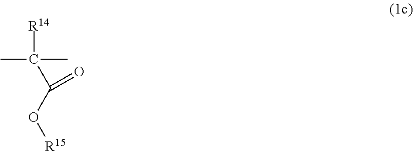

wherein R¹⁴ is a hydrogen atom or a monovalent organic group;
and wherein R¹⁵ is a monovalent organic group having 1 to 20 carbon atoms in total.

With respect to R¹⁴, when R¹⁴ is a monovalent organic group, the monovalent organic group may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

With respect to R¹⁵, the monovalent organic group of R¹⁵ may be substituted or unsubstituted, and may include one or more heteroatoms, and may be saturated or unsaturated, and may be linear, branched or cyclic. In some embodiments, for example, the monovalent organic group is a monovalent hydrocarbon group. In some embodiments, for example, the monovalent hydrocarbon group is an aliphatic group. In some embodiments, for example, the aliphatic group is a linear aliphatic group. In some embodiments, for example, the aliphatic group is an alkyl group.

In some embodiments, for example, the A³ unit function as a spacer between the A¹ and A² groups, to increase space between the A¹ and A² groups so that their functional properties are better utilized.

In some embodiments, for example Q has between 1 to 10,000 units of A³ in total. In some embodiments, for example, Q has between 500 and 10,000 units of A¹ in total, and between 500 and 10,000 units of A² in total, and between 500 and 10,000 units of A³ in total. In some embodiments, for example, Q has between 500 and 5,000 units of A¹ in total, and between 500 and 5,000 units of A² in total, and between 500 and 5,000 units of A³ in total. In some embodiments, for example, Q has between 1,000 and 10,000 units of A¹ in total, and between 1,000 and 10,000 units of A² in total, and between 1,000 and 10,000 units of A³ in total. In some embodiments, for example, Q has between 1,000 and 5,000 units of A¹ in total, and between 1,000 and 5,000 units of A² in total, and between 1,000 and 5,000 units of A³ in total. In some embodiments, for example, Q has between 2,500 and 10,000 units of A¹ in total, and between 2,500 and 10,000 units of A² in total, and between 2,500 and 10,000 units of A³ in total. In some embodiments, for example, Q has between 2,500 and 5,000 units of A¹ in total, and between 2,500 and 5,000 units of A² in total, and between 2,500 and 5,000 units of A³ in total.

In some embodiments, for example, the ratio of the total number of units of A² to the total number of units of A³ is between 1:10 and 10:1. In some embodiments, for example, this ratio is between 1:1 and 5:1. In some embodiments, for example, this ratio is 1:1. If this ratio is above 1:10, it would be difficult for the curing of polymer. If this ratio is close to 1:0, it will become less economical to involve A³.

In some embodiments, for example, the ratio of the total number of units of A¹ to the total number of units of (A¹+A²+A³) is between 5:6 and 1:6. In some embodiments, for example, this ratio is between 4:5 and 1:6. In some embodiments, for example, this ratio is between 2:3 and 1:6. In embodiments, for example, this ratio is 1:3. If this ratio is above 5:6, it would be difficult for the curing of a coating composition including the polymer (see below). If this ratio is less than 1:6, the final cured coating will not have expected water repellent property.

In some embodiments, for example, the ratio of the total number of units of A¹ to the total number of units of Q is between 5:6 and 1:6. In some embodiments, for example, this ratio is between 4:5 and 1:6. In some embodiments, for example, this ratio is between 2:3 and 1:6. In embodiments, for example, this ratio is 1:3. If this ratio is above 5:6, it would be difficult for the curing of a coating composition including the polymer (see below). If this ratio is less than 1:6, the final cured coating will not have expected water repellent property.

Exemplary embodiments of the operative polymer include the following compounds having structural formulae (1.1) through (1.7):

R¹¹-A¹-A¹-A¹-A¹-A²-A²-A²-A²-R¹² (1.1)

R¹¹-A¹-A¹-A²-A²-R¹² (1.2)

R¹¹-A¹-A¹-A²-A²-A¹-A¹-A²-A²-R¹² (1.3)

R¹¹-A¹-A²-A¹-A²-A¹-A²-A¹-A²-R¹² (1.4)

R¹¹-A¹-A¹-R¹³-A²-A¹-R¹³-A²-A²-R¹³-A²-A¹-R¹² (1.5)

R¹¹-A¹-A¹-A²-A¹-A²-R¹³-A²-A¹-A¹-R¹² (1.6)

R¹¹-A¹-R¹³-A²-R¹³-A¹-R¹³-A²-R¹³-A¹-R¹³-A²-R¹³-A¹-R¹² (1.7).

### Second Aspect of the Operative Polymer

In another aspect, the operative polymer includes two or more side chains (SC¹) and two or more side chains (SC²).

The side chain (SC¹) has a structural formula (2a):

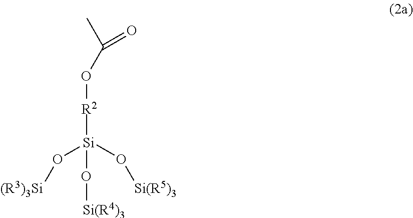

wherein each one of R², R³, R⁴ and R⁵ is the same as the corresponding R², R³, R⁴ and R⁵ in formula (1a).

The side chain (SC²) has a structural formula (2b):

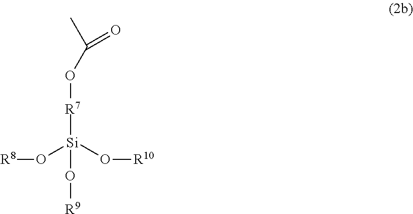

wherein each one of R⁷, R⁸, R⁹ and R¹⁰ is the same as the corresponding R⁷, R⁸, R⁹ and R¹⁰ in formula (1b).

In some embodiments, for example, the operative polymer includes a main chain (or backbone), and two or more side chains (SC¹), and two or more side chains (SC²), wherein the side chains (SC¹) and the side chains (SC²) extend from the main chain (or backbone). In some embodiments, for example, the two or more side chains (SC¹) is between 500 and 10,000 side chains (SC¹), and the two or more side chains (SC²) is between 500 and 10,000 side chains (SC²). In some embodiments, for example, the two or more side chains (SC¹) is between 500 and 5,000 side chains (SC¹), and the two or more side chains (SC²) is between 500 and 5,000 side chains (SC²). In some embodiments, for example, the two or more side chains (SC¹) is between 1,000 and 10,000 side chains (SC¹), and the two or more side chains (SC²) is between 1,000 and 10,000 side chains (SC²). In some embodiments, for example, the two or more side chains (SC¹) is between 1,000 and 5,000 side chains (SC¹), and the two or more side chains (SC²) is between 1,000 and 5,000 side chains (SC²). In some embodiments, for example, the two or more side chains (SC¹) is between 2,500 and 10,000 side chains (SC¹), and the two or more side chains (SC²) is between 2,500 and 10,000 side chains (SC²). In some embodiments, for example, the two or more side chains (SC¹) is between 2,500 and 5,000 side chains (SC¹), and the two or more side chains (SC²) is between 2,500 and 5,000 side chains (SC²).

In some embodiments, for example, the ratio of the total number of side chains (SC¹) to the total number of side chains (SC²) is between 20:1 and 1:1. It has been found that, above the lower limit, coating compositions incorporating such polymers have desirable hydrophobic characteristics while still displaying sufficient durability. If this ratio is above 20:1, it would be difficult to effect the association between the polymer and a substrate when the polymer is included within a coating composition that is applied to the substrate (see below). In some embodiments, for example, the ratio of the total number of side chains (SC¹) to the total number of side chains (SC²) is between 10:1 and 1:1. In some embodiments, for example, this ratio is between 5:1 and 1:1. In some embodiments, for example, this ratio is 2:1.

In some embodiments, for example, the operative polymer includes two or more of the side chains (SC¹), two or more of the side chains (SC²), and one or more side chains (SC³), wherein the side chain (SC³) has a structural formula (2c):

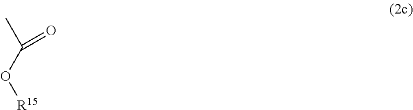

wherein R¹⁵ is the same as the corresponding R¹⁵ in formula 1(c).

In some embodiments, for example, the operative polymer includes a main chain (or backbone), and two or more side chains (SC¹), two or more side chains (SC²), and one or more side chains (SC³), wherein the side chains (SC¹), the side chains (SC²), and the side chains (SC³) extend from the main chain (or backbone). In some embodiments, for example, the two or more side chains (SC¹) is between 500 and 10,000 side chains (SC¹), the two or more side chains (SC²) is between 500 and 10,000 side chains (SC²), and the one or more side chains (SC³) is between 500 and 10,000 side chains (SC³). In some embodiments, for example, the two or more side chains (SC¹) is between 500 and 5,000 side chains (SC¹), the two or more side chains (SC²) is between 500 and 5,000 side chains (SC²), and the one or more side chains (SC³) is between 500 and 5,000 side chains (SC³). In some embodiments, for example, the two or more side chains (SC¹) is between 1,000 and 10,000 side chains (SC¹), the two or more side chains (SC²) is between 1,000 and 10,000 side chains (SC²), and the one or more side chains (SC³) is between 1,000 and 10,000 side chains (SC³). In some embodiments, for example, the two or more side chains (SC¹) is between 1,000 and 5,000 side chains (SC¹), the two or more side chains (SC²) is between 1,000 and 5,000 side chains (SC²), and the one or more side chains (SC³) is between 1,000 and 5,000 side chains (SC³). In some embodiments, for example, the two or more side chains (SC¹) is between 2,500 and 10,000 side chains (SC¹), the two or more side chains (SC²) is between 2,500 and 10,000 side chains (SC²), and the one or more side chains (SC³) is between 2,500 and 10,000 side chains (SC³). In some embodiments, for example, the two or more side chains (SC¹) is between 2,500 and 5,000 side chains (SC¹), the two or more side chains (SC²) is between 2,500 and 5,000 side chains (SC²), and the one or more side chains (SC³) is between 2,500 and 5,000 side chains (SC³).

In some embodiments, for example, the ratio of the total number of units of the side chain (SC²) to the total number of units of the side chain (SC³) is between 1:10 and 1:0. In some embodiments, for example, this ratio is between 1:10 and 10:1. In some embodiments, for example, this ratio is between 1:1 and 5:1. In some embodiments, for example, this ratio is 1:1. If this ratio is above 1:10, it would be difficult for the curing of polymer. If this ratio is close to 1:0, it will become less economical to involve the side chain (SC³).

In some embodiments, for example, the ratio of the total number of units of SC¹ to the total number of units of (SC¹+SC²+SC³) is between 5:6 and 1:6. In some embodiments, for example, this ratio is between 4:5 and 1:6. In some embodiments, for example, this ratio is between 2:3 and 1:6. In embodiments, for example, this ratio is 1:3. If this ratio is above 5:6, it would be difficult for the curing of a coating composition including the polymer. If this ratio is less than 1:6, the final cured coating will not have expected water repellent property.

In some embodiments, for example, the backbone includes, or is, a polymethylacrylate group.

### Third Aspect of the Operative Polymer

In another aspect, the operative polymer includes two or more structural units (SU¹) and two or more structural units (SU²).

The structural unit (SU¹) has a structural formula (3a):

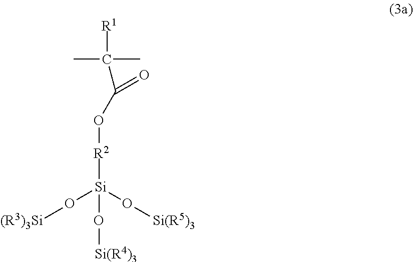

wherein each one of R¹, R², R³, R⁴ and R⁵ is the same as the corresponding R¹, R², R³, R⁴ and R⁵ in formula (1a).

The structural unit (SU²) has a structural formula (3b):

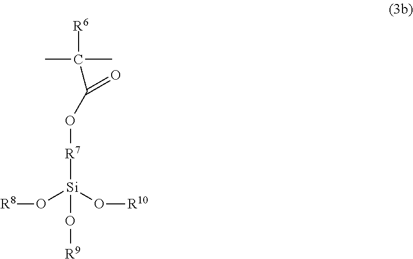

wherein each one of R⁶, R⁷, R⁸, R⁹ and R¹⁰ is the same as the corresponding R⁶, R⁷, R⁸, R⁹ and R¹⁰ in formula (1b).

In some embodiments, for example, the two or more structural units (SU¹) is between 500 and 10,000 structural units (SU¹), and the two or more structural units (SU²) is between 500 and 10,000 structural units (SU²). In some embodiments, for example, the two or more structural units (SU¹) is between 500 and 5,000 structural units (SU¹), and the two or more structural units (SU²) is between 500 and 5,000 structural units (SU²). In some embodiments, for example, the two or more structural units (SU¹) is between 1,000 and 10,000 structural units (SU¹), and the two or more structural units (SU²) is between 1,000 and 10,000 structural units (SU²). In some embodiments, for example, the two or more structural units (SU¹) is between 1,000 and 5,000 structural units (SU¹), and the two or more structural units (SU²) is between 1,000 and 5,000 structural units (SU²). In some embodiments, for example, the two or more structural units (SU¹) is between 2,500 and 10,000 structural units (SU¹), and the two or more structural units (SU²) is between 2,500 and 10,000 structural units (SU²). In some embodiments, for example, the two or more structural units (SU¹) is between 2,500 and 5,000 structural units (SU¹), and the two or more structural units (SU²) is between 2,500 and 5,000 structural units (SU²).

In some embodiments, for example, the ratio of the total number of structural units (SU¹) to the total number of structural units (SU²) is between 20:1 and 1:1. It has been found that, above the lower limit, coating compositions incorporating such polymers have desirable hydrophobic characteristics while still displaying sufficient durability. If this ratio is above 20:1, it would be difficult to effect the association between the polymer and a substrate when the polymer is included within a coating composition that is applied to the substrate (see below). In some embodiments, for example, this ratio is between 10:1 and 1:1. In some embodiments, for example, this ratio is between 5:1 and 1:1. In some embodiments, for example, this ratio is 2:1.

In some embodiments, for example, each one of the structural units (SU¹) includes side chain (SC¹), and each one of the structural units (SU²) includes side chain (SC²).

In some embodiments, for example, the operative polymer includes 50 to 99.9999 weight percent of the combination of the structural units (SU¹) and the structural units (SU²), based on the total weight of operative polymer. In some embodiments, for example, the operative polymer includes 85 to 99.9999 weight percent of the combination of the structural units (SU¹) and the structural units (SU²), based on the total weight of operative polymer.

In some embodiments, for example, the operative polymer includes the two or more structural units (SU¹), the two or more structural units (SU²), and one or more structural units (SU³).

The structural unit (SU³) has a structural formula (3c):

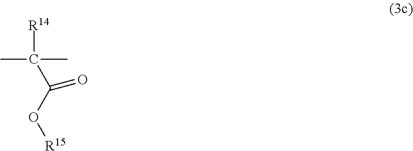

wherein each one of R¹⁴ and R¹⁵ is the same as the corresponding R¹⁴ and R¹⁵ in formula (1c).

In some embodiments, for example, the two or more structural units (SU¹) is between 500 and 10,000 structural units (SU¹), the two or more structural units (SU²) is between 500 and 10,000 structural units (SU²), and the one or more structural units (SU³) is between 500 and 10,000 structural units (SU³). In some embodiments, for example, the two or more structural units (SU¹) is between 500 and 5,000 structural units (SU¹), the two or more structural units (SU²) is between 500 and 5,000 structural units (SU²), and the one or more structural units (SU³) is between 500 and 5,000 structural units (SU³). In some embodiments, for example, the two or more structural units (SU¹) is between 1,000 and 10,000 structural units (SU¹), the two or more structural units (SU²) is between 1,000 and 10,000 structural units (SU²), and the one or more structural units (SU³) is between 1,000 and 10,000 structural units (SU³). In some embodiments, for example, the two or more structural units (SU¹) is between 1,000 and 5,000 structural units (SU¹), the two or more structural units (SU²) is between 1,000 and 5,000 structural units (SU²), and the one or more structural units (SU³) is between 1,000 and 5,000 structural units (SU³). In some embodiments, for example, the two or more structural units (SU¹) is between 2,500 and 10,000 structural units (SU¹), the two or more structural units (SU²) is between 2,500 and 10,000 structural units (SU²), and the one or more structural units (SU³) is between 2,500 and 10,000 structural units (SU³). In some embodiments, for example, the two or more structural units (SU¹) is between 2,500 and 5,000 structural units (SU¹), the two or more structural units (SU²) is between 2,500 and 5,000 structural units (SU²), and the one or more structural units (SU³) is between 2,500 and 5,000 structural units (SU³).

In some embodiments, for example, each one of the structural units (SU³) includes side chain (SC³).

In some embodiments, for example, the ratio of the total number of units of the structural unit (SU²) to the total number of units of the structural unit (SU³) is between 1:10 and 1:0. In some embodiments, for example, this ratio is between 1:10 and 10:1. In some embodiments, for example, this ratio is between 1:1 and 5:1. In some embodiments, for example, this ratio is 1:1. If this ratio is above 1:10, it would be difficult for the curing of polymer. If this ratio is close to 1:0, it will become less economical to involve (SC³).

In some embodiments, for example, the ratio of the total number of units of SU¹ to the total number of units of (SU¹+SU²+SU³) is between 5:6 and 1:6. In some embodiments, for example, this ratio is between 4:5 and 1:6. In some embodiments, for example, this ratio is between 2:3 and 1:6. In embodiments, for example, this ratio is 1:3. If this ratio is above 5:6, it would be difficult for the curing of polymer. If this ratio is less than 1:6, the final cured coating will not have expected water repellent property.

### Method of Making the Operative Polymer

In another aspect, an operative polymer is obtained by copolymerizing a monomer (M¹) and a monomer (M²) within a reaction zone.

The monomer (M¹) has a structural formula (4a), as follows:

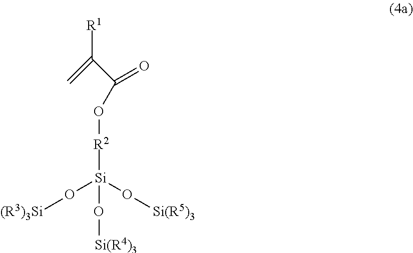

wherein each one of R¹, R², R³, R⁴ and R⁵ is the same as the corresponding R¹, R², R³, R⁴ and R⁵ in formula (1a).

The monomer (M²) has a structural formula (4b), as follows:

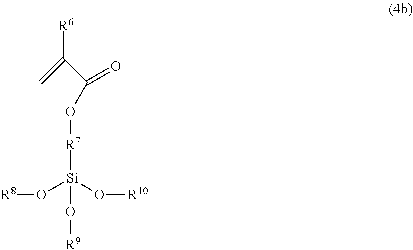

wherein each one of R⁶, R⁷, R⁸, R⁹ and R¹⁰ is the same as the corresponding R⁶, R⁷, R⁸, R⁹ and R¹⁰ in formula (1b).

In some embodiments, for example, the polymerization is free radical polymerization. In some of these embodiments, for example, the polymerization is heat initiated, irradiation initiated, or initiated by both heat and radiation. In some embodiments, for example, the irradiation, or the radiation, includes ultraviolet (UV) radiation and plasma.

In some embodiments, for example, the operative polymer is obtained by co-polymerizing the monomer (M¹) and the monomer (M²), wherein the monomer (M¹) and the monomer (M²) are included within a reaction mixture disposed within a reaction zone, and wherein the monomer (M¹) is present within the reaction mixture in an amount of 0.0001 to 99.9 weight percent of monomer (M¹), based on the total weight of the reaction mixture, and the monomer (M²) is present within the reaction mixture in an amount of 0.01 to 99.9999 weight percent, based on the total weight of the reaction mixture.

In some embodiments, for example, the operative polymer is obtained by co-polymerizing the monomer (M¹) and the monomer (M²) within a reaction zone, wherein the monomer (M¹) and the monomer (M²) are included within a reaction mixture disposed within a reaction zone, and wherein the monomer (M¹) is present within the reaction mixture in an amount of 5 to 90 weight percent of monomer (M¹), based on the total weight of the reaction mixture, and the monomer (M²) is present within the reaction mixture in an amount of 10 to 95 weight percent, based on the total weight of the reaction mixture.

In some embodiments, for example, the operative polymer is obtained by co-polymerizing the monomer (M¹) and the monomer (M²) within a reaction zone, wherein the monomer (M¹) and the monomer (M²) are included within a reaction mixture disposed within a reaction zone, and wherein, within the reaction mixture, the ratio of moles of the monomer (M¹) to moles of the monomer (M²) is between 20:1 and 1:1. It has been found that, above the lower limit, coating compositions incorporating such polymers have desirable hydrophobic characteristics while still displaying sufficient durability. If this ratio is above 20:1, it would be difficult to effect the association between the polymer and a substrate when the polymer is included within a coating composition that is applied to the substrate (see below). In some embodiments, for example, this molar ratio is between 10:1 and 1:1. In some embodiments, for example, this molar ratio is between 5:1 and 1:1. In some embodiments, for example, this ratio is 2:1.

In some embodiments, for example, the operative polymer is obtained by copolymerizing the monomer (M¹), the monomer (M²), and a monomer (M³) within a reaction zone. The monomer (M³) has a structural formula (4c), as follows:

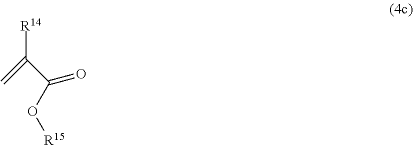

wherein each one of R¹⁴ and R¹⁵ is the same as the corresponding R¹⁴ and R¹⁵ in formula (1c).

In some embodiments, for example, the operative polymer is obtained by co-polymerizing the monomer (M¹), the monomer (M²), and the monomer (M³), wherein the monomer (M¹), the monomer (M²), and the monomer (M³) are included within a reaction mixture disposed within a reaction zone, wherein the monomer (M¹) is present within a reaction mixture in an amount of 20 to 99.9 weight percent of monomer (M¹), based on the total weight of the reaction mixture, and the monomer (M²) is present within the reaction mixture in an amount of 0.01 to 55 weight percent, based on the total weight of the reaction mixture, and the monomer (M³) is present within the reaction mixture in an amount of 0 to 25 weight percent, based on the total weight of the reaction mixture.

In some embodiments, for example, the operative polymer is obtained by co-polymerizing the monomer (M¹), the monomer (M²), and the monomer (M³), wherein the monomer (M¹), the monomer (M²), and the monomer (M³) are included within a reaction mixture disposed within a reaction zone, and wherein the monomer (M¹) is present within a reaction mixture in an amount of 55 to 93 weight percent of monomer (M¹), based on the total weight of the reaction mixture, and the monomer (M²) is present within the reaction mixture in an amount of 5 to 30 weight percent, based on the total weight of the reaction mixture, and the monomer (M³) is present within the reaction mixture in an amount of 2 to 15 weight percent, based on the total weight of the reaction mixture.

In some embodiments, for example, the operative polymer is obtained by co-polymerizing the monomer (M¹), the monomer (M²), and the monomer (M³), wherein the monomer (M¹), the monomer (M²), and the monomer (M³) are included within a reaction mixture disposed within a reaction zone, and wherein the ratio of the total number of units of the monomer (M¹) to the total number of units of the monomer (M³) is between 1:10 and 1:0. In some embodiments, for example, this ratio is between 1:1 and 5:1. In some embodiments, for example, the ratio is above 1:1. If the ratio is above 1:10, it would be difficult to cure the polymer. If the ratio is close to 1:1, it becomes less economical to use the monomer (M³).

In some embodiments, for example, the ratio of the total number of units of M¹ to the total number of units of (M¹+M²+M³) is between 5:6 and 1:6. In some embodiments, for example, this ratio is between 4:5 and 1:6. In some embodiments, for example, this ratio is between 2:3 and 1:6. In embodiments, for example, this ratio is 1:3. If this ratio is above 5:6, it would be difficult for the curing a coating composition including the polymer (see below). If this ratio is less than 1:6, the final cured coating will not have expected water repellent property.

### Coating Composition

There is also provided a coating composition comprising an operative polymer material and an operative solvent material. The operative polymer material consists of one or more of the operative polymers described above. The operative solvent material consists of one or more operative solvents. The operative solvent is configured to solubilize at least a fraction of any amount of the operative polymer material. In some embodiments, for example, substantially all of the operative polymer material is dissolved within the operative solvent material.

In some embodiments, for example, within the coating composition, the ratio of the weight of operative polymer material to the weight of the operative solvent material is between 4:1 and 1:100,000. In some embodiments, for example, within the coating composition, the ratio of the weight of operative polymer material to the weight of the operative solvent material is between 1:10 and 1:10,000. In some embodiments, for example, within the coating composition, the ratio of the weight of operative polymer material to the weight of the operative solvent material is between 1:20 and 1:1,000.

In some embodiments, for example, the operative polymer has a weight average molecular weight (Mw) of between 2000 and 500,000, a number average molecular weight (Mn) of between 2000 and 500,000, and a polydispersity index (Mw/Mn) between 1 and 10. In some embodiments, for example, the operative polymer has a weight average molecular weight (Mw) of between 10,000 and 500,000, a number average molecular weight (Mn) of between 10,000 and 500,000, and a polydispersity index (Mw/Mn) of between 1 and 7. In some embodiments, for example, the operative polymer has a weight average molecular weight (Mw) of between 50,000 and 500,000, a number average molecular weight (Mn) of between 50,000 and 500,000, and a polydispersity index (Mw/Mn) of between 1 and 5. If the weight average molecular weight (Mw) exceeds 500,000, it will be difficult to re-disperse the polymer in the solvent and the final coating will impair the appearance of the treated substrate. If the operative polymer has a molecular weight that is less than 2,000, it would be difficult to cure the operative polymer.

In some embodiments for example, the operative solvent functions to solubilize the operative polymer for facilitating its transport into contact engagement relationship with, and adhesion to the substrate. Suitable exemplary operative solvents include toluene, xylene, ethyl acetate, tetrahydrofuran, acetone, and ethanol.

In some embodiments, for example, the coating composition further includes a catalyst material.

In some embodiments, for example, the coating composition includes: (i) 0.0001 to 20 weight percent of the operative polymer material, based on the total weight of coating composition, and (ii) 1×10⁻⁹ to 1×10⁻³ weight percent of the catalyst material, based on the total weight of the coating composition, and (iii) 80 to 99.9999 weight percent of the operative solvent material, based on the total weight of the coating composition. In some embodiments, for example, the coating composition includes (i) 0.01 to 10 weight percent of the operative polymer material, based on the total weight of the coating composition, and (ii) 1×10⁻⁵ to 1×10⁻³ weight percent of the catalyst material, based on the total weight of the coating composition, and (iii) 89-99.98999 weight percent of the operative solvent material, based on the total weight of the coating composition. In some embodiments, for example, the coating composition includes: (i) 0.1 weight percent of the operative polymer material, based on the total weight of the coating composition, and (ii) 0.00002 weight percent of the catalyst material, based on the total weight of the coating composition, and (iii) 99.89998 weight percent of the operative solvent material, based on the total weight of the coating composition. If the relative amount of the catalyst material exceeds 1×10⁻³ weight percent, based on the total weight of the coating composition, production of the coating composition may become uneconomical due to excessive cost of the required catalyst material. If the relative amount of the catalyst material is less than 1×10⁻⁹ weight percent, based on the total weight of the coating composition, production of the coating composition may become uneconomical due to excessive cost of labour.

In some embodiments, for example, the ratio of the total number of units of the monomer M², being copolymerized for effecting production of the operative polymer of the coating composition, to the total number of units of catalyst material is between 1:5×10⁻¹⁰ and 1:5×10⁻⁴. In some embodiments, for example, the ratio of the total number of units of the monomer M², being copolymerized for effecting production of the operative polymer of the coating composition, to the total number of units of catalyst material is between 1:5×10⁻⁶ and 1:5×10⁻⁴. In some embodiments, for example, the ratio of the total number of units of the monomer M², being copolymerized for effecting production of the operative polymer of the coating composition, to the total number of units of catalyst material is 1:5×10⁻⁵. If this ratio is less than 1:5×10⁻⁴, that will be uneconomical for the cost of catalyst; and if this ratio exceeds 1:5×10⁻¹⁰, that will be uneconomical for the cost of labor.

In some embodiments, for example, the ratio of the total number of units A², of the operative polymer, to the total number of units of catalyst material is between 1:5×10⁻¹⁰ and 1:5×10⁻⁴. In some embodiments, for example, the ratio of the total number of units of A², of the operative polymer, to the total number of units of catalyst material is between 1:5×10⁻⁶ and 1:5×10⁻⁴. In some embodiments, for example, the ratio of the total number of units of A², of the operative polymer, to the total number of units of catalyst material is 1:5×10⁻⁵. If this ratio is less than 1:5 ×10⁻⁴, that will be uneconomical for the cost of catalyst; and if this ratio exceeds 1:5×10⁻¹⁰, that will be uneconomical for the cost of labor.

In some embodiments, for example, the catalyst material effects hydrolysis and coupling of siloxane groups to the substrate. In some embodiments, for example, the substrate includes hydroxyl groups that react with the siloxane groups in a hydrolysis reaction,

In some embodiments, for example, the catalyst material includes an organotin compound. In some embodiments, for example, the catalyst material includes dibutyltin dilaurate.

In some embodiments, for example, the coating composition may, but not necessarily, additionally include other materials, such as fillers, extenders, dispersants, surfactants, and pigments. In some of these embodiments, such other materials are present within the coating compositions in amounts that do not materially adversely affect the solubility of the operative polymer material within the operative.

### Use of Coating Composition

The coating composition is applied to a substrate so as to effect contact engagement relationship between the coating composition and the substrate. Such application includes that effected by deposition of the coating composition on the substrate, or by coating of the substrate with the coating composition. In response to the contact engagement relationship, production is effected of a material layer (or “film”) that is adhered to the substrate.

In some embodiments, for example, the application of the coating composition on the substrate includes that by brushing, brush painting, spraying, or dipping.

In some embodiments, for example, the adhesion of the material layer is to at least a portion of the surface material of the substrate. In some embodiments, for example, the adhesion of the material layer is to at least a portion of the substrate surface material and also to a portion of the substrate disposed below the substrate surface material of the substrate. The adhesion to a portion of the substrate disposed below the substrate surface material is effected after the application of the coating composition to the substrate, and after the applied coating composition has penetrated the substrate through an opening in the substrate surface material of the substrate so as to become disposed in contact engagement relationship with a subsurface portion of the substrate.

In some embodiments, for example, the adhesion includes chemical bonding between the material layer and the substrate. In some of these embodiments, for example, the chemical bonding is effected by the hydrolysis reaction between siloxane groups of the operative polymer and the hydroxyl groups of the substrate. In some embodiments, for example, the adhesion includes physical adhesion between the material layer and the substrate. For example, physical adhesion or attachment may occur between the operative polymer and a substrate surface which is metallic.

It is understood that one or more portions of the substrate, including the surface of the substrate, may become modified, (physically, or chemically, or both physically and chemically) in response to, at least, the contact engagement of the coating composition with the substrate. The term “substrate” is intended to cover the substrate prior to such contact engagement, as well as any modified form it assumes in response to such contact engagement. As well, the term “substrate surface material” is intended to cover the substrate surface material prior to such contact engagement, as well as any modified form it assumes in response to such contact engagement.

In some embodiments, for example, the contacting of the coating composition with the substrate is effected by applying the coating composition onto a substrate surface material of the substrate, and the substrate surface material of the substrate is relatively less hydrophobic than the operative surface material whose production is effected by, at least, the contacting of the coating composition with the substrate. In some embodiments, for example, the operative surface material is configured for interacting with a water droplet disposed on the operative surface material, such that, under the same environmental conditions, the contact angle of the operative surface material-disposed water droplet is greater than the contact angle of a water droplet disposed on the substrate surface material of the substrate.

In some embodiments, for example, after the application of the coating composition, the applied coating composition is cured so as to effect production of a cured material layer (or “film”). Curing includes evaporation of the operative solvent material. In some embodiments, for example, the curing includes the supply of an artificial heat input.

In some embodiments, for example, the contact angle of a water droplet on the operative surface material of the cured material layer in ambient air at a temperature of 20 degrees Celsius, at a pressure of one (1) atmosphere, and at a relative humidity of between 30 percent and 50 percent, is greater than 90 degrees. In some embodiments, for example, the contact angle of a water droplet on the operative surface material in ambient air at a temperature of 20 degrees Celsius, at a pressure of one (1) atmosphere, and at a relative humidity of between 30 percent and 50 percent, is greater than 110 degrees. In some embodiments, for example, the contact angle of a water droplet on the operative surface material in ambient air at a temperature of 20 degrees Celsius, at a pressure of one (1) atmosphere, and at a relative humidity of between 30 percent and 50 percent, is greater than 120 degrees. In some embodiments, for example, the contact angle of a water droplet on the operative surface material in ambient air at a temperature of 20 degrees Celsius, at a pressure of one (1) atmosphere, and at a relative humidity of between 30 percent and 50 percent, is greater than 150 degrees.

In some embodiments, for example, the sliding angle of a water droplet, having a volume of between 20 μl to 30 μl, on the operative surface material of the cured material layer in ambient air at a temperature of 20 degrees Celsius, at a pressure of one (1) atmosphere, and at a relative humidity of between 30 percent and 50 percent, is less than 80 degrees. In some embodiments, for example, the sliding angle of a water droplet, having a volume of between 20 μl and 30 μl, on the operative surface material in ambient air at a temperature of 20 degrees Celsius, at a pressure of one (1) atmosphere, and at a relative humidity of between 30 percent and 50 percent, is less than 40 degrees. In some embodiments, for example, the sliding angle of a water droplet, having a volume of between 20 μl and 30 μl, on the operative surface material in ambient air at a temperature of 20 degrees Celsius, at a pressure of one (1) atmosphere, and at a relative humidity of between 30 percent and 50 percent, is between 10 degrees and 40 degrees.

Suitable substrates include, for example, wood, glass, masonry, steel, aluminium, fabrics, ceramic, concrete. The substrate can be natural or can be man-made. The substrate surface may be optionally cleaned, polished, and/or otherwise pretreated or activated in order to improve adhesion to the applied (or deposited) coating composition.

In some embodiments, for example, the substrate is an article to which another coating composition has been applied or deposited.

Further embodiments will now be described in further detail with reference to the following non-limitative examples.

### Example 1

For preparing polymer A2, four equivalents of tri(trimethylsilyloxy)silyl propyl methacrylate (monomer (a)), one equivalent of trimethoxysilyl propyl methacrylate (monomer (b)), and one equivalent of methyl methacrylate (monomer (c)) were mixed in 100 ml toluene (functioning as a solvent) under stirring and protection of N₂. 0.02 g Azobisisbutyronitrile was then added to the mixture to initiate the polymerization at 70° C. The reaction was continued over 36 hours. After that, the reaction solution was rotevaporated to remove the toluene. A light yellow color liquid (that included polymer A2) was collected with a yield of 98 percent (i.e. 2 weight percent of polymer A2 was removed with the solvent).

The molecular weight of each one of the prepared polymers was measured by gel permeation chromatography (GPC). The instrument used was a Viscotek™ TDA-302 size exclusion chromatograph (Viscotek™) equipped with tetra detectors refractive index (RI), UV, viscosity (VISC), and two-angle laser light scattering (7° and 90°, λ=670 nm)]. PS sample (Viscotek™) with a stated peak molecular weight of 99,500 g/mol and a molecular weight distribution (“MWD”) of 1.03 was used to calibrate the instrument. Tetrahydrofuran (“THF”) was used as the mobile phase at a flow rate of 1.0 mL/min and the column temperature of 30° C. The samples were dissolved in THF with the sample concentrations of 2.0 mg/mL, depending on molecular weight of the polymer, and 100 μL of such solution was injected to start data collection. The data obtained was analyzed using OmniSEC™ software. The produced polymer (i.e. polymer A2) had a weight average molecular weight (Mw) of 91,600, a number average molecular weight (Mn) of 29,400, and a polydispersity index (Mw/Mn) of 3.2.

Polymers A1, A3, A4, and A5 were prepared using an identical procedure as that used for preparing polymer A2, with the exception that the ratio of starting monomers (a), (b), and (c) were different in each case. The ratios of starting monomers (a), (b), and (c), used in the preparation of polymers A1 to A5, are identified in Table 1.

TABLE 1
The molar ratio of starting monomers (a),
(b) and (c) for preparing polymers A1 to A5

| | A1 | A2 | A3 | A4 | A5 |
|---|---|---|---|---|---|
| a:b:c | 10:1:1 | 4:1:1 | 2:1:1 | 1:1:1 | 1:5:0 |

In preparing each one of the polymers A6 to A10, the ratio of starting monomers (a), (b) and (c) were fixed in the molar ratio of 4:1:1, and each one of the groups R² and R⁷ is propyl, and the groups R¹, R³, R⁴, R⁵, R⁶, R⁸, R⁹, R¹⁰, R¹⁴, and R¹⁵ (R³, R⁴, and R⁵ are the same, and R⁸, R⁹, and R¹⁰ are the same) were tuned, in the manner set out in Table 2, so as to prepare polymers A6 to A10.

TABLE 2
R¹, R³, R⁴, R⁵, R⁶, R⁸, R⁹,
R¹⁰, R¹⁴, and R¹⁵ groups in polymers A6 to A10

| | R¹ | R⁶ | R¹⁴ | R¹⁵ | R³, R⁴, R⁵ | R⁸, R⁹, R¹⁰ |
|---|---|---|---|---|---|---|
| A6 | H | H | H | CH₃ | CH₃ | CH₃ |
| A7 | H | H | H | CH₃ | CH₂CH₃ | CH₃ |
| A8 | CH₃ | CH₃ | CH₃ | CH₃ | CH₂CH₃ | CH₃ |
| A9 | CH₃ | CH₃ | CH₃ | CH₃ | CH₂CH₂OCH₃ | CH₃ |
| A10 | CH₃ | CH₃ | CH₃ | CH₂CH₃ | CH₂CH₃ | CH₃ |

The solubility of each of polymers A1 to A10 is listed in Table 3, below.

TABLE 3
Solubility of polymers A1 to A10

| | | | | | | Ethyl |
|---|---|---|---|---|---|---|
| Solvent | Xylene | Toluene | Ethanol | Isopropanol | Acetone | acetate |
| A1 | Good | Good | Good | Good | Good | Good |
| A2 | Good | Good | Good | Good | Good | Good |
| A3 | Good | Good | Good | Good | Good | Good |
| A4 | Good | Good | Slightly | Slightly | Good | Good |
| A5 | Good | Good | Slightly | Slightly | Slightly | Good |
| A6 | Good | Good | Slightly | Good | Good | Good |
| A7 | Good | Good | Slightly | Good | Good | Good |
| A8 | Good | Good | Slightly | Good | Good | Good |
| A9 | Good | Good | Good | Good | Good | Good |
| A10 | Good | Good | Good | Good | Good | Good |

### Example 2

Hydrophobic characteristics of various coating compositions, prepared from the polymeric compounds prepared in Example 1, were evaluated, when the coating compositions were applied to woods and ceramic tiles.

Solutions were prepared, from each one of the prepared polymers A1 to A10, by dispersing the respective polymer, along with dibutyltin dilaurate (as the catalyst) in ethanol, such that each one of the solutions included 5 weight percent of the combination of the respective polymer and the catalyst, based on the total weight of the solution, with the catalyst present at a concentration of 20 ppm. 20 μl of each solution was brushed on each substrate (woods and ceramic tiles) over an area of 4 cm². The coated samples were cured at ambient conditions over 6 hours. Tap water droplets were used for measuring the static contact angle (10 μl) and sliding angle (30 μl). Table 4 illustrates measured water contact angles and sliding angles on coated and uncoated woods. Table 5 illustrates measured water contact angles and sliding angles on coated and uncoated ceramic tiles. NA means that the sliding angle was over 90° on measured surfaces.

TABLE 4
Water contact angles and sliding angles on woods*

| | | Spruce | | Hard wood | | White wood | |
|---|---|---|---|---|---|---|---|
| Substrates | | Uncoated | Coated | Uncoated | Coated | Uncoated | Coated |
| A1 | CA(°) | 70 ± 15 | 95 ± 10 | 85 ± 10 | 100 ± 5 | 75 ± 5 | 100 ± 10 |
| | SA (°) | NA | 80 ± 8 | NA | NA | NA | 60 ± 7 |
| A2 | CA(°) | 70 ± 15 | 145 ± 5 | 85 ± 10 | 135 ± 5 | 75 ± 5 | 142 ± 6 |
| | SA (°) | NA | 50 ± 5 | NA | 65 ± 5 | NA | 15 ± 5 |
| A3 | CA(°) | 70 ± 15 | 140 ± 10 | 85 ± 10 | 135 ± 10 | 75 ± 5 | 140 ± 5 |
| | SA (°) | NA | 40 ± 8 | NA | 50 ± 10 | NA | 32 ± 8 |
| A4 | CA(°) | 70 ± 15 | 105 ± 12 | 85 ± 10 | 95 ± 10 | 75 ± 5 | 110 ± 5 |
| | SA (°) | NA | 70 ± 10 | NA | NA | NA | 85 ± 5 |
| A5 | CA(°) | 70 ± 15 | 110 ± 10 | 85 ± 10 | 105 ± 8 | 75 ± 5 | 110 ± 6 |
| | SA (°) | NA | 45 ± 5 | NA | 50 ± 4 | NA | 38 ± 6 |
| A6 | CA(°) | 70 ± 15 | 142 ± 10 | 85 ± 10 | 138 ± 5 | 75 ± 5 | 145 ± 6 |
| | SA (°) | NA | 52 ± 5 | NA | 55 ± 5 | NA | 25 ± 5 |
| A7 | CA(°) | 70 ± 15 | 138 ± 5 | 85 ± 10 | 135 ± 7 | 75 ± 5 | 140 ± 6 |
| | SA (°) | NA | 50 ± 7 | NA | 60 ± 8 | NA | 22 ± 7 |
| A8 | CA(°) | 70 ± 15 | 128 ± 10 | 85 ± 10 | 130 ± 4 | 75 ± 5 | 136 ± 10 |
| | SA (°) | NA | 45 ± 6 | NA | 55 ± 6 | NA | 20 ± 10 |
| A9 | CA(°) | 70 ± 15 | 125 ± 8 | 85 ± 10 | 120 ± 5 | 75 ± 5 | 130 ± 6 |
| | SA (°) | NA | 45 ± 4 | NA | 60 ± 6 | NA | 40 ± 6 |
| A10 | CA(°) | 70 ± 15 | 133 ± 6 | 85 ± 10 | 130 ± 3 | 75 ± 5 | 138 ± 5 |
| | SA (°) | NA | 46 ± 5 | NA | 45 ± 7 | NA | 30 ± 5 |

*CA means water static contact angle and SA means water sliding angle on the substrates

TABLE 5
Water static contact angles and sliding angles on
the surfaces of uncoated and coated ceramic tiles*

| Substrates | | Uncoated | Coated |
|---|---|---|---|
| A1 | CA (°) | 30 ± 5 | 70 ± 3 |
| | SA (°) | NA | 75 ± 5 |
| A2 | CA (°) | 30 ± 5 | 105 ± 5 |
| | SA (°) | NA | 45 ± 5 |
| A3 | CA (°) | 30 ± 5 | 96 ± 7 |
| | SA (°) | NA | 40 ± 6 |
| A4 | CA (°) | 30 ± 5 | 110 ± 3 |
| | SA (°) | NA | 45 ± 6 |
| A5 | CA (°) | 30 ± 5 | 107 ± 5 |
| | SA (°) | NA | 36 ± 8 |
| A6 | CA (°) | 30 ± 5 | 110 ± 5 |
| | SA (°) | NA | 60 ± 5 |
| A7 | CA (°) | 30 ± 5 | 112 ± 4 |
| | SA (°) | NA | 52 ± 5 |
| A8 | CA (°) | 30 ± 5 | 104 ± 6 |
| | SA (°) | NA | 46 ± 6 |
| A9 | CA (°) | 30 ± 5 | 116 ± 6 |
| | SA (°) | NA | 40 ± 6 |
| A10 | CA (°) | 30 ± 5 | 120 ± 4 |
| | SA (°) | NA | 38 ± 6 |

*CA means water static contact angle and SA means water sliding angle on the substrates

In terms of each kind of sample above, two parallel samples were prepared and tested. On each single sample, ten (10) different spots were randomly selected and tested, and average errors were calculated. It was found that, in the testing of sliding angle, there were no trails of water left behind after the water droplet slid off of the coated woods and coated ceramic tiles.

### Example 3

A PTFE emulsion (sigma-adrich) was also applied to coat the woods and ceramic tiles. PTFE emulsion was diluted to 5 weight percent and coated on the substrates, which were cured at 120° C. over 2 hours. After that, all the samples were washed by ethanol and water to remove the surfactants that come from the emulsion. When the samples were dried, contact angles were tested. However, no water repellent samples were attained. PTFE treated samples showed hydrophilic property, which should because of the deep absorbed surfactants in the substrates.

### Example 4

Hydrophobic characteristics of various coating compositions, prepared from the polymeric compounds prepared in Example 1 were evaluated, when the coating compositions were applied to glass slides, and steel and aluminium blocks.

Solutions were prepared, from each one of the prepared polymers A1 to A10, by dispersing the respective polymer, along with dibutyltin dilaurate (as the catalyst) in ethanol, such that each one of the solutions included 3 weight percent of the combination of the respective polymer and the catalyst, based on the total weight of the solution, with the catalyst present at a concentration of 20 ppm. Glass slides and steel blocks were dipped in the prepared solutions, and then cured at ambient conditions over 6 hours. Subsequently, tap water droplets were used for measuring the static contact angle (10 μl) and sliding angle (30 μl) measurements. The surfaces of aluminum and steel blocks were polished by sands paper before coating. Table 6 illustrates the measured water contact angles and sliding angles for the coated and the uncoated surfaces of the substrates.

TABLE 6
Water contact angles and sliding angles
on glass, steel and aluminum blocks*

| | | Glass slides | | Steel blocks | | Aluminum blocks | |
|---|---|---|---|---|---|---|---|
| Substrates | | Raw | Coated | Raw | Coated | Raw | Coated |
| A1 | CA (°) | 70 ± 15 | 105 ± 3 | 85 ± 10 | 105 ± 2 | 75 ± 5 | 106 ± 3 |
| | SA (°) | NA | 65 ± 5 | NA | 56 ± 3 | NA | 50 ± 2 |
| A2 | CA (°) | 70 ± 15 | 120 ± 2 | 85 ± 10 | 110 ± 2 | 75 ± 5 | 105 ± 4 |
| | SA (°) | NA | 38 ± 5 | NA | 33 ± 3 | NA | 45 ± 5 |
| A3 | CA (°) | 70 ± 15 | 118 ± 2 | 85 ± 10 | 110 ± 3 | 75 ± 5 | 106 ± 2 |
| | SA (°) | NA | 40 ± 5 | NA | 30 ± 6 | NA | 46 ± 4 |
| A4 | CA (°) | 70 ± 15 | 122 ± 2 | 85 ± 10 | 110 ± 5 | 75 ± 5 | 102 ± 4 |
| | SA (°) | NA | 30 ± 6 | NA | 28 ± 4 | NA | 36 ± 4 |
| A5 | CA (°) | 70 ± 15 | 125 ± 3 | 85 ± 10 | 112 ± 2 | 75 ± 5 | 104 ± 3 |
| | SA (°) | NA | 32 ± 3 | NA | 26 ± 3 | NA | 34 ± 4 |
| A6 | CA (°) | 70 ± 15 | 122 ± 3 | 85 ± 10 | 115 ± 2 | 75 ± 5 | 108 ± 3 |
| | SA (°) | NA | 28 ± 4 | NA | 28 ± 4 | NA | 34 ± 2 |
| A7 | CA (°) | 70 ± 15 | 120 ± 2 | 85 ± 10 | 117 ± 4 | 75 ± 5 | 106 ± 2 |
| | SA (°) | NA | 30 ± 2 | NA | 28 ± 3 | NA | 32 ± 2 |
| A8 | CA (°) | 70 ± 15 | 118 ± 3 | 85 ± 10 | 115 ± 4 | 75 ± 5 | 107 ± 3 |
| | SA (°) | NA | 28 ± 4 | NA | 30 ± 2 | NA | 32 ± 2 |
| A9 | CA (°) | 70 ± 15 | 110 ± 2 | 85 ± 10 | 105 ± 3 | 75 ± 5 | 103 ± 2 |
| | SA (°) | NA | 33 ± 3 | NA | 35 ± 3 | NA | 36 ± 2 |
| A10 | CA (°) | 70 ± 15 | 118 ± 4 | 85 ± 10 | 112 ± 2 | 75 ± 5 | 105 ± 2 |
| | SA (°) | NA | 26 ± 4 | NA | 30 ± 4 | NA | 33 ± 3 |

*CA means water static contact angle;
SA means water sliding angle;
NA means SA is over 90°

### Example 5

Hydrophobic characteristics of various coating compositions, prepared from the polymeric compounds prepared in Example 1 were evaluated, when the coating compositions were applied to fabric.

Solutions were prepared, from each one of the prepared polymers A1 to A10, by dispersing the respective polymer, along with dibutyltin dilaurate (as the catalyst) in ethanol, such that each one of the solutions included 5 weight percent of the combination of the respective polymer and the catalyst, based on the total weight of the solution, with the catalyst present at a concentration of 20 ppm. 0.5 g of each solution was used to coat fabrics (cotton, lab cloth) over an area of 4×4 cm². The coatings were cured at ambient conditions over 6 hours. Table 7 illustrates the surface properties of the fabrics before and after the application of the coating.

TABLE 7
Surface properties of fabrics before and after hydrophobic treatment*

| | Uncoated | A1 | A2 | A3 | A4 | A5 | A6 | A7 | A8 | A9 | A10 |
|---|---|---|---|---|---|---|---|---|---|---|---|
| Feeling | Soft | Slightly | Soft | Soft | Soft | Soft | Slightly | Slightly | Soft | Soft | Soft |
| | | rigid | | | | | rigid | rigid | | | |
| CA(°) | 0 | 145 ± 5 | 140 ± 5 | 140 ± 5 | 140 ± 5 | 145 ± 2 | 142 ± 4 | 144 ± 5 | 138 ± 6 | 138 ± 3 | 140 ± [symbol] |
| SA(°) | — | NA | 28 ± 5 | 40 ± 5 | 35 ± 5 | 32 ± 3 | 30 ± 2 | 32 ± 3 | 35 ± 2 | NA | 36 ± 4 [symbol] |

*tap water was used for the static contact angle (10 μl water droplet size) and sliding angle (30 μl water droplet size) measurements; all the angles were measured after the droplets were put on the surface for 30 sec.
NA means that the sliding angle is over 90° on measured surfaces.
CA means contact angle.
SA means sliding angle. [symbol]
indicates data missing or illegible when filed

### Example 6

A solution was prepared by dispersing polymer A2, along with dibutyltin dilaurate (as the catalyst) in ethanol, such that the solution included 5 weight percent of the combination of the polymer A2 and the catalyst, based on the total weight of the solution, with the catalyst present at a concentration of 20 ppm.

Six (6) spruce samples were provided (each 2×2×1 cm). Three (3) were coated with the prepared solution, and three (3) remained uncoated. The coated and uncoated spruce pieces were kept in tap water for 24 hours. After that, excess water on samples was wiped off by tissues. All of samples were weighted before and after soaked in water. The water absorption of samples were calculated by the equation,

Water absorption percentage gain=(100×(Wₐ−W₀)/W₀) percent,

wherein Wa is the weight of sample after absorbing of water and W₀ is the weight of sample before soaked in water.

The non-coated spruce samples had an average 46 percent gain by weight.

The coated one had a 7 percent gain by weight.

### Example 7

Durability of coating composition was tested.

Solutions were prepared, from each one of prepared polymers A1, A2, A3, A6, A7, A8, A9, and A10, by dispersing the respective polymer, along with dibutyltin dilaurate (a the catalyst) in isopropanol, such that each one of the solutions included 5 weight percent of the combination of the respective polymer and the catalyst, based on the total weight of the solution, with the catalyst present at a concentration of 20 ppm.

Solutions were also prepared, from each one of the prepared polymers A4 and A5, by dispersing the respective polymer, along with dibutyltin dilaurate (acting as the catalyst) in ethyl acetate, such that each one of the solutions included 5 weight percent of the combination of the polymer A2 and the catalyst, based on the total weight of the solution, with the catalyst present at a concentration of 20 ppm.

20 ml of each one of the prepared solutions was deposited in a respective vial. All the vials were capped but not completely sealed, and then put on the shelf. In 3 months, no sample was found gelled, blurred or precipitated.

### Example 8

Durability of coating compositions was also evaluated. Polymer A2 and dibutyltin dilaurate (acting as the catalyst) were dispersed in ethanol, such that a solution was prepared that included 5 weight percent of the combination of the polymer A2 and the catalyst, based on the total weight of the solution, with the catalyst present at a concentration of 20 ppm. 0.1 ml of the solution was coated on various wood and ceramic tile substrates over an area of 0.015 m². The coated samples were cured at ambient conditions over 6 hours.

The coated woods and ceramic tiles were put on the shelf, where they could access the sunshine. The contact angles and sliding angles were measured weekly. Table 8 illustrates the measured water contact angles and the sliding angles.

TABLE 8
Water contact angles and sliding angles on substrates

| | Spruce | | Pine | | White wood | | Ceramic tile | |
|---|---|---|---|---|---|---|---|---|
| | 1 | 6 | 1 | 6 | 1 | 6 | 1 | 6 |
| Substrates | month | months | month | months | month | months | month | months |
| Contact | 145 ± 5 | 135 ± 8 | 150 ± 5 | 140 ± 8 | 120 ± 5 | 115 ± 5 | 105 ± 5 | 103 ± 3 |
| angles (°) | | | | | | | | |
| Sliding | 50 ± 5 | 45 ± 8 | 65 ± 5 | 60 ± 10 | 15 ± 5 | 25 ± 5 | 45 ± 5 | 50 ± 5 |
| angles (°) | | | | | | | | |

Moreover, it was found the appearance of the substrates shows no changes in over 12 months.

### Example 9

The pH stability of a coating composition, applied to spruce, was also tested. Polymer A3 and dibutyltin dilaurate (acting as the catalyst) were dispersed in ethanol, such that a solution was prepared that included 5 weight percent of the combination of the polymer A3 and the catalyst, based on the total weight of the solution, with the catalyst present at a concentration of 20 ppm. 20 μl of the solution was brushed on spruce samples over an area of 4 cm². The coated spruce samples were tested under various acid or basic conditions. Test specimens, of various pH values, were randomly dropped on the coated spruce sample surface in at least 5 spots. The dosage of liquid was 30 μl/drop and mustard was 0.05 ml/drop. The results are illustrated in Table 9.

TABLE 9
pH stability testing on hydrophobic treated spruce

| | | 5 min | 10 min | 30 min | 60 min | 120 min |
|---|---|---|---|---|---|---|
| pH Buffer | 2 | Failed | — | — | — | — |
| | 5 | Water | Failed | — | — | — |
| | | repellent | | | | |
| | 8 | Water | Water | Water | Water | Water |
| | | repellent | repellent | repellent | repellent | repellent |
| | 9 | Water | Water | Water | Water | Water |
| | | repellent | repellent | repellent | repellent | repellent |
| Soft drinks and | Lemon | Failed | — | — | — | — |
| seasonings | pH = 2-3 | | | | | |
| | Orange | Water | Water | Water | Failed but | — |
| | juice | repellent | repellent | repellent | no marks on | |
| | pH = 3-4 | | | | the surface | |
| | Black | Water | Water | Water | Water | Failed but |
| | coffee | repellent | repellent | repellent | repellent | no marks on |
| | pH = 5 | | | | | the surface |
| | mustard | Water | Water | Water | Water | Failed but |
| | pH = 4-5 | repellent | repellent | repellent | repellent | no marks on |
| | | | | | | the surface |

The term “failed” is used to indicate that a low hydrophobic effect was observed.

### Example 10

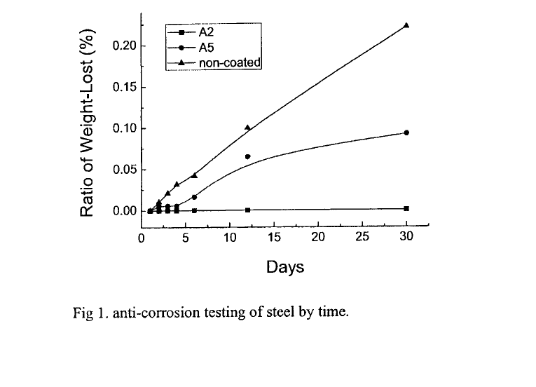

The corrosion protection characteristics of the coating composition, when applied to steel blocks, were also evaluated. Solutions were prepared, from each of prepared polymers A2 and A5, by dispersing the respective polymer, along with dibutyltin dilaurate (as the catalyst) in ethanol, such that each one of the solutions included 5 weight percent of the combination of the polymer A2 and the catalyst, based on the total weight of the solution, with the catalyst present at a concentration of 20 ppm. Steel blocks were coated with the solutions and cured at ambient conditions for over six (6) hours. After that, the coated steel blocks were immersed in tap water (pH=6) over a period of time (days). The weight of the steel blocks was recorded daily. The ratio of weight-loss was recorded as a function of time, and is illustrated in FIG. 1.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1.-46. (canceled)

47. A polymer having the structural formula:
R¹¹QR¹²;
wherein R¹¹ is a hydrogen atom, a hydroxyl group, or a monovalent organic group;
and wherein R¹² is a hydrogen atom, a hydroxyl group, or a monovalent organic group;
and wherein Q represents P_{N};
and wherein P, in each occurrence, independently, is A¹, A², or R¹³,
and wherein A¹ has the structural formula (1a): 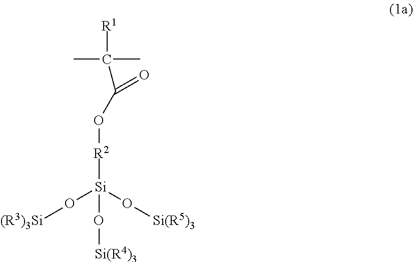
wherein R¹ is a hydrogen atom, or a monovalent organic group having 1 to 10 carbon atoms in total;
and wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein A² has the structural formula (1b): 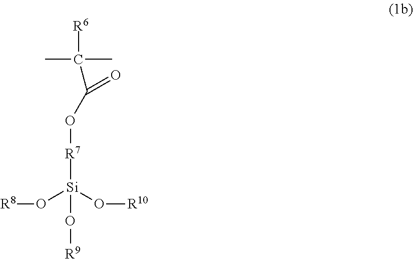
and wherein R⁶ is a hydrogen atom or a monovalent organic group having 1 to 10 carbon atoms in total;
and wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁰ is a monovalent organic group having 1 to 15 carbon atoms in total;
and wherein R¹³ is a divalent organic group;
and wherein N is an integer that is greater than or equal to two (2);
with the proviso that Q has at least two (1) but less than 10,000 units of A¹ in total, and at least two (1) but less than 10,000 units of A² in total.

48. The polymer as claimed in claim 47.
wherein P, in each occurrence, independently, is A¹ or A².

49. The polymer as claimed in claim 48;
wherein Q has between 500 and 10,000 units of A¹ in total, and between 500 and 10,000 units of A² in total.

50. The polymer as claimed in claim 49;
wherein the ratio of the total number of units of A¹ to the total number of units of A² is between 20:1 and 1:10.

51. The polymer as claimed in claim 50;
wherein the ratio of the total number of units of A¹ to the total number of units of Q is between 5:6 and 1:6.

52. The polymer as claimed in claim 51;
wherein Q includes at least one unit of A³, wherein A³ has the structural formula (1c): 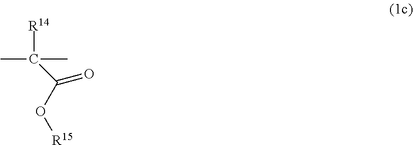
wherein R¹⁴ is a hydrogen atom or a monovalent organic group;
and wherein R¹⁵ is a monovalent organic group having 1 to 20 carbon atoms in total;
wherein the ratio of the total number of units of A² to the total number of units of A³ is between 1:10 and 10:1.

53. The polymer as claimed in claim 51;
wherein Q includes at least one unit of A³, wherein A³ has the structural formula (1c): 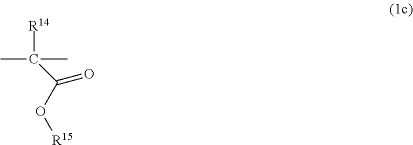
wherein R¹⁴ is a hydrogen atom or a monovalent organic group;
and wherein R¹⁵ is a monovalent organic group having 1 to 20 carbon atoms in total;
and wherein the ratio of the total number of units of A¹ to the total number of units of (A¹+A²+A³) is between 5:6 and 1:6.

54. A polymer comprising two or more structural units (SU¹) and two or more structural units (SU²);
wherein the structural unit (SU¹) has a structural formula (3a): 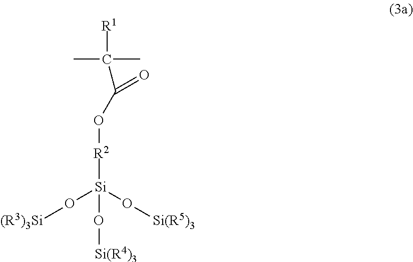
wherein R¹ is a hydrogen atom, or a monovalent organic group having 1 to 10 carbon atoms in total;
and wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein the structural unit (SU²) has a structural formula (3b): 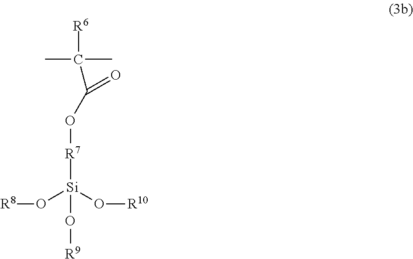
wherein R⁶ is a hydrogen atom or a monovalent organic group having 1 to 10 carbon atoms in total;
and wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁰ is a monovalent organic group having 1 to 15 carbon atoms in total.

55. A polymer obtained by co-polymerizing monomers within a reaction mixture disposed within a reaction zone, wherein the monomers include monomer (M¹) and monomer (M²);
wherein the monomer (M¹) has a structural formula (4a), as follows: 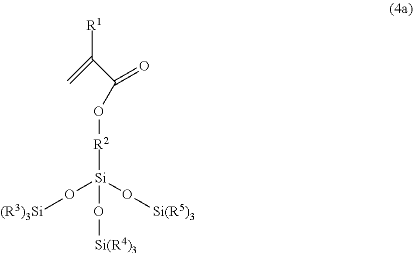
wherein R¹ is a hydrogen atom, or a monovalent organic group having 1 to 10 carbon atoms in total;
and wherein R² is a divalent organic group having 1 to 12 carbon atoms in total;
and wherein R³ is a monovalent organic group having 1 to 15 carbon atoms in total;
and wherein R⁴ is a monovalent organic group having 1 to 15 carbon atoms in total;
and wherein R⁵ is a monovalent organic group having 1 to 15 carbon atoms in total;
and wherein the monomer (M²) has a structural formula (4b), as follows: 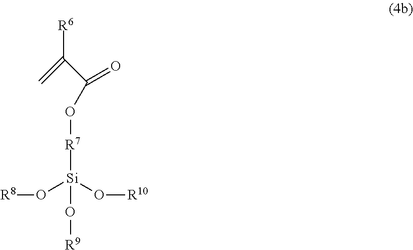
wherein R⁶ is a hydrogen atom or a monovalent organic group having 1 to 10 carbon atoms in total;
and wherein R⁷ is a divalent organic group having 1 to 12 carbon atoms in total;
and wherein R⁸ is a monovalent organic group having 1 to 15 carbon atoms in total;
and wherein R⁹ is a monovalent organic group having 1 to 15 carbon atoms in total;
and wherein R¹⁹ is a monovalent organic group having 1 to 15 carbon atoms in total.

56. The polymer as claimed in claim 55;
wherein R¹ is an alkyl group having 1 to 10 carbon atoms in total;
and wherein R² is an alkylene group having 1 to 12 carbon atoms in total;
and wherein R³ is an alkyl group having 1 to 15 carbon atoms in total;
and wherein R⁴ is an alkyl group having 1 to 15 carbon atoms in total;
and wherein R⁵ is an alkyl group having 1 to 15 carbon atoms in total;
and wherein R⁶ is an alkyl group having 1 to 10 carbon atoms in total;
and wherein R⁷ is an alkylene group having 1 to 12 carbon atoms in total;
and wherein R⁸ is an alkyl group having 1 to 15 carbon atoms in total;
and wherein R⁹ is an alkyl group having 1 to 15 carbon atoms in total;
and wherein R¹⁰ is an alkyl group having 1 to 15 carbon atoms in total.

57. The polymer as claimed in claim 56;
wherein, within the reaction mixture, the ratio of moles of the monomer (M¹) to moles of the monomer (M²) is between 20:1 and 1:1.

58. The polymer as claimed in claim 57;
wherein the monomers further include a monomer (M³), and wherein the monomer (M³) has a structural formula (4c), as follows: 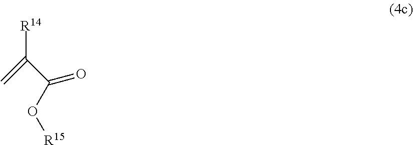
wherein each one of R¹⁴ and R¹⁵ is the same as the corresponding R¹⁴ and R¹⁵ in formula (1c).
wherein the ratio of the total number of units of M¹ to the total number of units of (M¹+M²+M³) is between 5:6 and 1:6.

59. A coating composition comprising an operative polymer material and an operative solvent material, wherein the operative polymer material consists of the polymer of claim 47, and wherein the operative solvent material consists of one or more operative solvents.

60. The coating composition as claimed in claim 59;
wherein the polymer has a weight average molecular weight (Mw) of between 2000 and 500,000, a number average molecular weight (Mn) of between 2000 and 500,000, and a polydispersity index (Mw/Mn) between 1 and 10.

61. The coating composition as claimed in claim 60;
wherein the ratio of the weight of operative polymer material to the weight of the operative solvent material is between 4:1 and 1:100,000.

62. The coating composition as claimed in claim 61, further comprising a catalyst material.

63. The coating composition as claimed in claim 62;
wherein the operative polymer material is present in an amount of 0.0001 to 20 weight percent, based on the total weight of coating composition,
and wherein the catalyst material is present in an amount of 1×10⁻⁹ to 1×10⁻³ weight percent, based on the total weight of the coating composition;
and wherein the operative solvent material is present in an amount of 80 to 99.9999 weight percent, based on the total weight of the coating composition.

64. The coating composition as claimed in claim 63;
wherein the operative polymer is obtained by copolymerizing monomer (M¹) and monomer (M²) within a reaction zone;
and wherein the ratio of the total number of units of the monomer M², being copolymerized for effecting production of the operative polymer of the coating composition, to the total number of units of catalyst material is between 1:5×10⁻¹⁰ and 1:5×10⁻⁴.

65. The coating composition as claimed in claim 64;
wherein the ratio of the total number of units A², of the operative polymer, to the total number of units of catalyst material is between 1:5×10⁻¹⁰ and 1:5×10⁻⁴.
